(19) United States
(12) Patent Application Publication
(10) Pub. No.: US 2006/0140134 A1
(43) Pub. Date: Jun. 29, 2006

(54) Advertising business method and system for secure and high speed transmission of media files across an internet, intranet or cable network, and method to avoid digital file sharing or copying

(75) Inventors: Sean M. O'Brien, Enterprise, AL (US); Robert M. Donnelli, Scottsdale, AZ (US); John Jason Gentry Mullins, Pleasanton, CA (US)

Correspondence Address: John J G Mullins, 1618 East Gate Way #304, Pleasanton, CA, 94566, US

(73) Assignee: Boloto, Inc.

(21) Appl. No.: 11/319,308

(22) Filed: Dec. 27, 2005

Related U.S. Application Data
(60) Provisional application No. 60/639,513, filed on Dec. 28, 2004.

(51) Int. Cl. H04J 1/16

(52) U.S. Cl. 370/252

(57) ABSTRACT

The present invention provides a computer system and software that implements and supports a method to permit a digital media peer-to-peer or peer to server exchange while providing a secure and high speed transmission of media files across an internet, intranet or cable network in such a manner as to avoid illegal or un-permitted end user digital file sharing or copying. More particularly, the invention provides a method that combines a digital media encryption technique and unique user key to permit transmission of digital media information in a very compressed or compacted small-size file that is essentially incapable of being decoded without a legitimate user key.

### TECHNICAL FIELD

The present invention relates generally to a computer system running software with software logic that provides a secure private or virtual private network for network users that are identified by the network as having permission for network access as either a member or guest and also provides an enhanced way for advertisers to obtain services of network providers or the network system in identifying and targeting specific network users or group of users for advertiser sponsoring of all or part of a network user's secure and high speed transmission of media files across an internet, intranet and cable network, or sponsor other network services, in exchange for network promoting and offering of advertiser's products or services to the targeted network user or group of users. More particularly, the invention includes secure file storage and transfer methods, encrypted digital files, and associated software that include use of a scattered fragment encryption technique, an encrypted reassembly index for reassembling decoded fragments into a digital file in real time and one or more unique user keys. This method permits transmission of information in a very compressed or compacted small-size files that are essentially incapable of being decoded without a legitimate user key and unencrypted index. In a preferred aspect the secure private or virtual private network provides and promotes a method of legitimate, paid multimedia file transfers by identified network users in a way that avoids multimedia or software digital file sharing or copying without direct or indirect payment of licensing fees for using such software or accessing multimedia files.

### BACKGROUND

Illegal digital file sharing and pirating have increasingly become a problem on the internet for media based digital recordings. Unlike traditional television media broadcasts and hard copy media tracking of the origin of copies and capturing revenue streams is difficult. Copying and transmitting a digital file can be quite simple and quick. Traditionally, the large amount of time necessary to record and transmit media along with the loss of quality tended to limit degrees of pirating and transmission of such recorded media. Imbedded, logos, watermarks, and other tracking mechanisms have also been used to discourage copying. Further, with TV, Cable TV, Cable Digital Audio, Satellite TV and Satellite digital audio, there can be some mitigation of revenue streams due to paid advertisements to the media producer with respect to a particular audience.

Research has indicated that published media producers would be happy with the enhanced and quicker sharing of media via the internet, if adequate controls were in place. They would need to have a reliable method to adequately and efficiently manage and track file exchanges in such a way as to assure them of obtaining proper licensing payments for use of the media. However, there is currently no acceptable and efficient way for media producers to track such media file transfers in real time and to then collect the proper license fees for their use. Once the media is transfer to a computer, copies are frequently made and transferred around in traditional and non-traditional ways. At the present time both legal and illegal transfers of media routinely occur that are expensive to monitor and to collect legitimate royalty revenue from such illegal or unauthorized transfers.

Moreover, current file-sharing methods over the internet do not provide an efficient way to transfer media use fees from end user to advertisers of products that might be interested in paying media royalty or user fees on the behalf of certain end users in exchange for targeted advertising. The identity of the consumer audience on the internet is difficult to ascertain and the effectiveness of internet advertising campaigns are difficult to accurately quantify. Usually, advertisements can only track the cost of clicks per thousand targeted internet viewers and cannot accurately correlate this information with real-time purchases of their advertised products in the real world or in real time.

Encryption methods for transmitted data have traditionally slowed the transmission of data to a point that end users do not want to use such systems or need to have a special and expensive translation unit provided by the media producer. Further, such encryption methods are often quickly broken by internet hackers or hardware chip producers.

U.S. Pat. No. 5,818,935 issued to Maa relates to a method for including within a media stream an internet pointer (such as a URL) to a secret location for a media stream. This method is a clumsy attempt to regulate internet transfers of digital data from digital broadcasters and is similar to a secure cable or TV satellite system. It does not relate to direct transfers of digital media and does not use a high level encryption method. Further, Maa does not provide a means for advertisers to target particular end users with the ability to pay for their use of digital media if the end user agrees.

U.S. Pat. No. 6,357,042 issued to Srinivasan relates to a method for coordinating two streams of media data. In the '042 patent one stream of data is encoded as a digital recording with location “tags” for later inserting additional media. The main purpose seems to be to make a TV set interactive to enhance pay-per-view broadcasts. While this document alludes to later insertion of advertisement data, there is little information about how this is to be done. There are no details about data encryption and it appears that the encryption discussed is the encryption ordinarily present in satellite or cable TV broadcasts. No method for coordinating the end use with specific targeted advertisement is discussed.

U.S. Pat. No. 4,621,285 issued to Schilling relates to a method for separating out vertical and horizontal TV broadcast information and sending it unencrypted over a cable or satellite network. The data to synchronize the horizontal and vertical information is encoded or encrypted. The display system decodes the synchronization data, combines the horizontal and vertical information in a synchronized manner and displays the TV media. There is no discussion of digital media files or encoding the media stream. Advertising is not discussed in this document.

Accordingly, there is a strong need in the art for a business method and system that could solve one or more of the three factors needed to solve the above mentioned problems; to provide for secure digital transfers, to adequate payment of end users or advertisers for use of the media, and provide a means for clearly identifying the end user of digital media no matter where the user wants to obtain the digital media. There is especially needed a method for transferring files in a smaller compressed and/or compacted manner in order to enhance transfer speeds where the system is nearly impossible to be broken and can be quickly changed or adapted to avoid problems when a code is broken.

### SUMMARY OF THE INVENTION

An object of the invention is to provide a computer system having at least some memory, interface, and at least one software module running in its memory that includes software logic providing a secure private or virtual private network for network users that are identified by the network as having permission for network access as a member or guest and also providing an enhanced way for advertisers to secure the services of network providers or of the network system in identifying and targeting specific network users or group of users for advertiser sponsoring of all or part of such network user or group of users secure and high speed transmission of media files across an internet, intranet and cable network, or sponsor other network services, in exchange for the network targeted promoting and offering of advertiser's products or services to the targeted network user or group of users, comprising:

(i) computer software including software logic and at least one interface for a network user to be identified by the network as a known prior user, or to provide to the network through the interface enough identifying information to qualify as a newly identified network user, with sufficient permission to access the private or virtual private network,

(ii) computer software including software logic sufficient to verify a network user's identify, and track the network connection of the network user as the network user accesses the private network or virtual private network system, and

(iii) computer software implementing a business method for (a) accurately identifying and connecting specific network users who wish to access digital media or obtain services offered on the network, (b) identifying product or services advertisers who wish to target said network users with advertisements in exchange for such advertisers sponsoring such network users free or reduced access or services costs when they access digital media files or obtain services offered on the network, (c) providing an interface for such product or services advertisers to select network users to target and to obtain the right to target and sponsor such specific network users, and (d) providing the targeted specific network users with such sponsored digital media access or services.

In one object of the invention, the above secure private or virtual private network, the software enhanced and supported business method includes the use of a computer system with software logic implementing at least one method step for accurately identifying the end user of the digital media and at least one method step for a product advertiser to use a computer system to select the target group to which the end user belongs. More particularly, in a preferred object of the invention, the business method comprises use of a computer system to register or record data of end users for an actual or virtual digital media card whose unique identifier key (or keys) can be utilized by the private network system, or virtual private network system, to initiate decoding of encrypted media for the identified end user. In one object, the media card registration step includes requesting adequate information related to marketing factors such that the end user may be identified with a particular class of consumers that share at least one marketing factor in common, while optionally keeping individual identities from advertisers.

In one object of the invention, the media card identity of an network user is cross-referenced with consumer information of that end user, which information is accessible to the network system and media card identity and the consumer information can be used by the network system to provide the network user with access to a media player system having decoding information such that it will allow the media card user sponsored access to media files by initiating decoding of such media files in exchange for the media card user being targeted by a sponsor. Optionally, the library card media user can forego sponsored access of the media file or being targeted by an advertisement by agreeing to directly pay a media-use fee for using the digital media whereupon decoding can occur that is cross-referenced with the media card identity and a file that records payment of the media access fee by of the end user in a way that can be tracked by associated network software logic. The business method and the network user's secure access to the network are best implement by a method for encrypting and decoding (decrypting digital media) that is more fully described herein.

It is an important object of the invention to provide a computer system (particularly a system attached to the internet) and a method for reliably encrypting a digital media file in a compressed/compacted format that is secure against hackers. In a preferred object, the digital media file is equipped with imbedded information regarding where advertisements can be inserted, or when advertisements can be played . . . such as before the media is played or simultaneously with the media in a window, banner or background.

In a more preferred object the invention includes scattered digital files and software for generating and utilizing such files, wherein such scattered digital files are generated from ordinary digital files by software that breaks up the ordinary digital file into fragments and encrypts each fragments utilizing a scattered fragment encryption technique, which is similar to bit torrent fragmentation generation techniques except that the order of the fragments is scrambled and fragments are encrypted, in combination with an encrypted reassembly index with information regard the names, order and decryption keys for decoding and reassembling decoded fragments temporarily into a portion of the digital file in real time. After scatter fragmentation and encryption, digital media files do not exist in their original form and only exist as scattered digital files within the private or virtual private network or within a network connected computer (when downloaded from the network), may not be located in a single contiguous file or even in an identifiable digital media file, and cannot be transferred as decoded digital files by usual file transfer methods. Use of the scattered digital files by decryption and reassembly can only initiated and the decryption and reassembly of the media file continued to provide the digital media access experience in real time if unique user key(s) associated with the network end user are available that grants the end user an access right to the digital media.

In a preferred object of the invention, even the encrypted reassembly index corresponding to a particular scattered digital media file may be further scatter fragmented and further encrypted such that the first encrypted reassembly index requires a second smaller encrypted reassembly index that includes encrypted instructions for reassembly of the first encrypted reassembly index. In a more preferred object, the encrypted media file is about 10 times smaller in file size as compared to the non-encrypted media to promote faster file transfers over the private network or virtual private network. Preferably, the encrypted file is from 20 to 500 times smaller than the non-encrypted file size, and more preferably the encrypted file is from 100 to 500 times smaller than the non-encrypted media file size.

It is another object of the invention to provide software logic and a method to fragment a media file into transfer packets (also known as bits of information) and encrypt the separate media file into uniquely identifiable packets whose order for decryption and playing of the packets is included within a separate encrypted reassembly index file. In a preferred object the decryption information operates in real time and only provides a buffer of decrypted media information that exists in the memory of a computer while the media is being played. Preferably, encrypted packets are sent to the end-user in a non-linear or random fashion and may be simultaneously sent to an end user sent from multiple locations in a manner similar to bit torrent file transfers.

It is a preferred object of the invention to transmit the individual packets and the encrypted reassembly index file from multiple locations simultaneously and asynchronously to an end user via a true distributed intelligent torrent exchange (DITX) transmission. A DITX transmission may be generally described as a file exchange where a torrent of packets for a media file are sent from multiple locations on the internet (or from other network locations) to a media requesting end user who is asking for a particular media file (a torrent of packets is sent like a swarm of bees from different locations that have the packets available for sending) and individual packets of the torrent are intelligently aware of their association to one another within the private network. In a preferred exchange, the encrypted reassembly index file and the first needed packets that correspond to the beginning of the media file are sent from the closest locations to permit the quickest real time decryption and use of the media file.

In one object of the invention, for times when the internet is unavailable, encrypted packets for a particular media file and its encrypted reassembly index file may optionally be stored in separate locations on a receiving end user computer or network and multiple packets may optionally be packed into single or multiple files on the receiving computer or network. Such file and packet location information may be added to an index upon their receipt and stored in an encrypted or non-encrypted fashion. A data source within the network or upon a target network computer of a network end user may be utilized to store encrypted packets and their corresponding reassembly index in a single file or in multiple separate files within the data source that may, or may not be readily associated with one another without the use of a reassembly index.

A preferred object of the invention is to provide a decryption system that decrypts multiply encrypted media via multiple decryption steps, wherein the a media player that is capable of playing the encrypted media performs a final decryption step during playing of media packets. Further preferred is such a system that includes an encryption system having at least two, preferably three encryption steps. Even more preferred is such a system that reduces the size of the encrypted file to a size that is many times smaller as compared to the original media file and utilizes loss-less encryption, i.e., the decryption reliably restores the original non-encrypted file without any loss of information. Most preferred is an encryption/decryption system wherein the data is encrypted at least three times.

Another object of the invention is to provide a method and software for capturing consumer factor information of an end user and cross-referencing with a data decryption key or keys contained within a file or files known as a “library card” within the context of this application.

Additional objects, advantages and novel features of the invention will be set forth in part in the description which follows, and in part will become apparent to those skilled in the art upon examination of the following, or may be learned by practice of the invention.

### DETAILED DESCRIPTION OF THE INVENTION

Definitions and Nomenclature

“Library card”, as used in the specification and the appended claims refers to a computer file or files that include unique information and keys associated with an individual person and an individual computer system that may be used with an information decryption system to present decrypted digital information to just that particular individual on that individual computer system. For an even higher lever of security the library card can be associated with a unique device and/or unique user identifier, such as an imbedded software or hardware identifier in a device or in the case of a unique user identifier . . . a password system, a retinal scanner identifier, a unique electronic identity card, a fingerprint recognition device or the like.

The term “digital media” refers to digitized audio, video or synchronized audio and video, and even to computer software.

The term “encryption” in the context of digital media refers to the use of one or more algorithms to translate digital information into a form that is not readable without the use of a key and software routine that can convert the encrypted file back into its original form. The use of the phrase “multiply encrypted” refers to a process of subjecting encrypted data to one or more additional encryptions.

The terms “decryption” and “multiply decrypted” are the opposite (reverse) procedure as described in “encryption” and “multiply encrypted” procedures described above and use one or more keys and/or software algorithm libraries to accomplish returning encrypted information to its original un-encrypted form.

The term “point-blank-exchange” refers to a computer system that allows advertisers to bid with an encrypted media provider for access to target groups of end users having a digital library card and offer to pay for the library card user's access to digital media in exchange for targeted advertising.

The term-“metadata” in an object data programming language context refers to information about the content of programming objects or data objects. One may think of it in lay terms as a description summary or index for describing present content or possible future content for an object programming language object. For example, chunks or pieces of digital data (whether encrypted or decrypted) may exist in an object or in a group of objects that are linked together in an object schema (structure or order).

Other object programming language terms and internet terms are to be given their ordinary and expected meaning within the context of this application. A meaning for such terms can be readily obtained by reviewing descriptive literature that is available from the author and provider of such object programming languages.

The term “distributed intelligent torrent exchange” or “DITX” is based upon the concept of packets of information that are embedded with metadata that causes the packets to become programming objects that are self-aware and are also aware of the group of objects to which they belong. Therefore a DITX exchange is where an end user, machine device or network requests a media file from a distributed computer system (such as the internet or another distributed network) and an intelligent torrent of packets are sent like a swarm of bees from multiple distributed locations to the requesting location. The DITX file transfer results from a DITX request initiated by an end user location that prompts the self-aware individual packets to respond by intelligently requesting their machine or network location to send a torrent of packets to the requesting location where they are unencrypted and re-assembled into the media file needed by the requestor. Since the individual packets are self-aware multiple locations can send an intelligent swarm of packets to the requesting location and provide a “parallel” instead of a “serial” file transfer exchange that is much faster than obtaining packets serially from one or more locations. This maximizes the bandwidth file download time, and still provides a method for a file transfer exchange that will require decryption and reassembly of the individual packets by the end user location whereby direct or indirect payment for use of the media file can be managed and controlled by the ultimate owner of the media file without requiring a central repository of the ultimate owner of the media file and the policing of all persons to whom the file has been transferred.

A “library card DITX file” is a media file that does not exist as a single file on an end user machine, but instead exists as a scrambled collective of individual packets of information (scattered fragment encryption technique) along with an encrypted reassembly index and at least one de-encryption software module. When the de-encryption software module determines from the library card identifier that the end user has permission to the media file the software module utilizes the encrypted reassembly index to decrypt the individual packets in their proper order to provide the media file for use of the end user.

A “NAN-e” device is a device that is embedded with a unique identifier chip or software that can be associated with a unique individual to whom that the devices belongs, such as through a specific library card holder identifier system, where library card is defined as above.

An “iTEN” or “intelligent true edge network” is a network where individual locations on the network use a NAN-e identifier, a library card identifier or a combination to permit the network to conclusively identify an end user location on a network, which then allows each location on the network to truly act as a distributed network where each location is not only a user (a “client”) but also a provider (a “server”) on the network. True intelligent two-way or multi-way networking is seamlessly provided as a result of exact identification for each location on the network. Such a network provides much better security and facilitates electronic commerce in a way that was never before possible.

### OVERVIEW OF THE INVENTION

The present invention and its implementation is based upon the discovery of unique ways to encrypt digital information and unique ways to associate or link the real-time decryption of that information with a particular end user and a particular computer system of that end user. Such discoveries of a scattered fragment encryption technique in combination with an encrypted reassembly index and a de-encryption software or hardware module make possible the digital library card concept and the point blank exchange concept (an advertiser auction for advertising rights in return for sponsoring digital media access or services use by network end users). The digital information is reliably encrypted and utilizes a firm or digital library card with proper access permission as a requirement to decrypt and access the digital information. In real time a library card can be granted access to the digital media regardless of how the digital media was obtained by the library card holder. Moreover, a third party can elect in advance to provide digital media at that third party's expense to a particular target audience when that audience requests it in exchange for specifically targeted advertising. Thus, the library card holder can elect to pay for the access or to allow a third party advertiser to pay for the access (when available).

In one embodiment the invention provides a computer system having at least some working memory, at least one interface, and at least one software module running in its memory that includes software logic providing a secure private or virtual private network for network users that are identified by the network as having permission for network access as either a member or guest and also providing an enhanced way for advertisers to secure the services of network providers or of the network system in identifying and targeting specific network users or group of users for advertiser sponsoring of all or part of such network user or group of users secure and high speed transmission of media files across an internet, intranet and cable network, or sponsor other network services, in exchange for the network targeted promoting and offering of advertiser's products or services to the targeted network user or group of users, comprising:

(i) computer software including software logic and at least one interface for a network user to be identified by the network as a known prior user, or to provide to the network through the interface enough identifying information to qualify as a newly identified network user, with sufficient permission to access the private or virtual private network,

(ii) computer software including software logic sufficient to verify a network user's identify, and track the network connection of the network user as the network user accesses the private network or virtual private network system, and

(iii) computer software implementing logic with a method for:
(a) accurately identifying and connecting specific network users to the network who wish to access digital media or obtain services offered on the network,
(b) identifying product or services advertisers who wish to target said network users with advertisements in exchange for such advertisers sponsoring such network users free or reduced access or services costs when they access digital media files or obtain services offered on the network,
(c) providing an interface for such product or services advertisers to select network users to target and to obtain the right to target and sponsor such specific network users, and
(d) providing the targeted specific network users with such sponsored digital media access or services.

In another embodiment the invention provides the secure private network or virtual private network as described above, wherein the software enhanced and software supported method includes providing a computer system with software logic implementing at least one method step for accurately identifying the end user of the digital media and at least one method step for a product advertiser to use a computer system to select the target group to which the end user belongs, wherein the software and computer system includes logic and at least one interface for registering or recording data of end users to provide an end users with an actual or virtual digital media card whose unique identifier key (or keys) can be utilized by the private network system, or virtual private network system, for identification and optionally to initiate decoding of encrypted media for the identified end user.

The secure private network or virtual private network as described above, can further comprise software logic and an interface providing for a media card registration step that includes requesting adequate information from end users related to marketing factors such that the end user may be identified with a particular class of consumers that share at least one marketing factor in common, while optionally preserving their individual identities from advertisers, and the data obtained from the registration step can be accessed by network logic to permit an advertiser to choose to sponsor the access of the end user to digital media or services available on or through the network.

In one embodiment, the invention provides such a secure private network or virtual private network, wherein the network includes logic and at least one interface providing for the network system to cross reference the media card identity of an network user with consumer information of that end user to make such information accessible to the network system, whereby the media card identity and the consumer information can be used by the network system to provide the network user with access to services available on the network or with access to a media player system having decoding information such that it will allow the media card user to have sponsored access to media files by initiating decoding of such media files in exchange for the media card user being targeted by a sponsor.

In a preferred embodiment, the above invention further provides a secure private network or virtual private network, wherein an identified library card media user is provided with an interface and option to forego sponsored access of a service or sponsored access to a media file available on or through the network, and is provided the option to avoid being targeted by an advertisement by agreeing to directly pay a services fee for such a service, or to pay a media use fee for using digital media whereupon decoding can occur that is cross-referenced with the media card identity and with a file that records payment of the media access fee by of the end user in such a way that it can be tracked by associated network software logic.

In another embodiment, the present invention provides a stand alone, network connected or internet connected computer system comprising a working memory, a storage device, a logic processor, at least one interface, and software logic for reliably encrypting a digital media file in a compressed/compacted format that provides a degree of security against hackers of the encrypted files, comprising:

(a) software logic for accessing a digital file to produce encrypted scattered digital files, wherein such scattered digital files are generated by:
(i) breaking or disassembling an ordinary digital file into scattered fragments and encrypting each fragments while providing an index for proper reassembly of the digital file, wherein the scattered fragments may be transmitted over the internet or a network utilizing a method similar to bit torrent fragmentation generation and reassembly techniques, except that the reassembly order of the fragments is scrambled, the individual fragments are encrypted and the fragments named without identifying their correct reassembly order, and an a fragment transmission or fragment reassembly index is generated, such that fragment transmission order and fragment names are optionally encrypting
(ii) generating one or more of an encrypted transmission or reassembly index with information regarding the names and order of transmission of fragments by ordered bit torrent, and regarding names, reassembly order and decryption keys for decoding and reassembling decoded fragments temporarily into a portion of the digital file in real time.

In still another embodiment, the invention provides a network or virtual network comprising at least one encrypted scattered digital file within the private or virtual private network or within a network connected computer, wherein the at least one scattered digital file requires the use of a decryption and reassembly index in order to be accessed and utilized as a digital file, and may require a fragment transmission index, and wherein such decryption and reassembly can only initiated and continued by an end user within the network or within a computer that has acquired such scattered digital file from the network to provide the end user with a digital media access experience in real time if unique user key(s) associated with the network end user are available that grants the end user an access right to the digital media and unlocks with decryption a decryption and reassembly index associated with the at least one encrypted scattered digital file.

The invention further provides such a network or virtual network, comprising providing software logic and a method to transmit the individual packets of at least one encrypted scattered fragmented digital media file as uniquely identifiable packets whose order for decryption and playing of the packets is included within a separate encrypted reassembly index file, and the individual packets or the encrypted reassembly index file are transmitted to an end user on the network from a single-location or from multiple locations simultaneously and asynchronously via a true distributed intelligent torrent exchange transmission.

More preferably, the invention provides such a network or virtual network, wherein the distributed intelligent torrent exchange may be generally described as a file exchange where a torrent of encrypted packets for an encrypted scattered fragmented digital media file are sent from multiple locations on the internet, or from other network locations, to an end user requesting the download and access to the digital media file.

In one embodiment, the above network or virtual network, is a network wherein the distributed intelligent torrent exchange is managed by network software including logic that provides transfer of the encrypted reassembly index file and the first needed packets that correspond to the beginning of the scattered digital media file from the closest locations to permit the quickest real time decryption and use of the digital media file. Preferably, the decryption information of the encrypted reassembly index file operates in real time and only provides a buffer of decrypted media information that exists in the memory of a computer while a portion of the digital media file is being played or accessed by the end user.

In a preferred embodiment, the network or virtual network described above further comprises at least one encrypted decryption and reassembly index, at least one digital file transmission download index, or at least one composite encrypted decryption and reassembly and digital file transmission download index, wherein the at least one encrypted decryption and reassembly index, at least one digital file transmission download index, or at least one composite encrypted decryption and reassembly and digital file transmission download index is readily identifiable to a network end user as being associated with a particular digital media file and can be readily shared with other network or non-network end users without sharing the right to access the index file or to access its associated digital media file, whereby index sharing is encouraged by the network system in order to provide the ability for end users to enjoy sponsored downloading and accessing of the associated digital media file through the network or virtual network as legitimately paid for digital media accessing.

Preferably, the above network or virtual network, further comprises software and at least one interface for advertisers to utilize to establish the right to sponsor all or part of an end user downloading and accessing of a digital media file through the network or virtual network as legitimately paid for digital media accessing.

In another embodiment the invention provides a scattered, fragmented and encrypted digital media file or encrypted index generated by the method of the invention as described above, wherein the digital media file or encrypted index may not be located in a single contiguous file or even in an identifiable digital media or index file, and may not be transferred as decoded digital files by usual file transfer methods. In a preferred embodiment of the invention, the scattered, fragmented and encrypted digital media file or encrypted index is provided, wherein the scattered, fragmented, encrypted digital media file, the encrypted decryption and reassembly index, or both, is includes or imbedded information regarding where advertisements can be inserted, or when advertisements can be played as part of the digital media access, including before the digital media is played or simultaneously with a part or all of the media access in a window, banner or background.

In a preferred embodiment, a encrypted reassembly index according to the invention as described above, corresponding to a particular scattered digital media file, is one wherein a first encrypted assembly index is further scatter fragmented and further encrypted at least one more to provide that the first encrypted reassembly index requires a second smaller encrypted reassembly index with included encrypted instructions in order for the first encrypted reassembly index itself to be decrypted and reassembled.

In one embodiment a scattered encrypted media file according to the invention is one wherein the scattered encrypted media can be stored as a file or as group of files that are individually or collectively from about 2 to 100 times smaller in file size as compared to the non-encrypted media file or to the collective non-encrypted fragments files in order to promote faster file transfers over the private network or virtual private network. Preferably, the scattered encrypted media can be stored as a file or as group of files which is individually or collectively from about 5 to 10 times smaller in file size as compared to the non-encrypted media file or to the collective non-encrypted fragments files.

In one embodiment, the network or virtual network according to the invention as described above, further comprises logic to provide on a receiving end user computer of a network user that is associated with or previously connected with the internet or network for times when the internet or network is unavailable to the end use, encrypted packets for a particular media file and its encrypted reassembly index file which may be stored in separate locations on the receiving end user computer or network and multiple packets may optionally be packed into single or multiple files on the receiving computer or network. Preferably, such file and packet location information may be added to a cross-referenced digital media file index of the end user upon their receipt and stored in an encrypted or non-encrypted fashion and may optionally utilize a data source within the end user computer system or within an offline network computer associated with the end user computer to store encrypted packets and their corresponding reassembly index in a single file or in multiple separate files that may, or may not be readily associated with one another without the use of a reassembly index.

Non-Limiting Description of a Digital Library Card Example

The basic premise of the Library Card (LC) Member (Or Boloto Card Member, BLTO) framework is to allow accelerated collaborative content (media, images, audio, etc) sharing and distribution in a way that assures the media producer receives their just remuneration for Library Card Member's access to the collaborative content. Unlike the traditional web based distributed application, a “client” in the Library Card Member is anything but a ‘thin’ client. Each “client” is both a consumer and a distributor of media in an intelligent true edge network (iTEN) where the LC or BLTO technology permits DITX transmissions file swapping. A “client” will coordinate with a master content provider that tracks the wide scale distribution of content across the virtual community. (Each client will have its own unique ID and also have unique user IDs, each with their own unique user profile, such that a user may access content from any unique client.) At the master's discretion, a “client” will either consume media directly from the master or from the Library Card Members (other clients in the virtual community). Therefore, in addition to local processing of content for analysis and application specific functions, clients will respond to the master content providers requests to actively participate in media distribution at the edge of the virtual community. In one embodiment, the Versant VAR product which has event/channel/reliable guaranteed delivery across WAN capabilities will be ideal for the Peer to Peer communications at the “edge” of the virtual community so much of its functionality can be reused in the following described implementation.

Client applications (holders of a Library Card) in the virtual community will contain a local repository of content that is of particular interest to that client application's user's interests.

Non-Limiting Illustrative Example of Client Application:

The population of local content will occur in one of the following events:
1. The client will request the content as a result of a search string submitted to MCP index volume or from its predefined play list. The predefined play list consists of content already stored locally.
2. The client will request recommended content from the MCP based on the user profile upon connection to the internet and arbitrarily through the course of the online connection period. The MCP will then will replicate the content to the local store so that it is in essence “pre fetching” content for the local media player making it immediately available for playback.
3. A local skin manager which is responsible for presenting advertising will also request content in the form of xml documents stored as objects. The events are also generated upon connection to the internet and arbitrarily through the course of the online connection period.

The client will ‘directly’ connect to a Master Content Provider as its source for new content requests. We call the MCP connection ‘direct’ because it is a fixed known connection for primary content acquisition.

Since the client application serves two independent functions, local application function and distribution function, the client application will need to be designed in a Multi-Thread, Multi-Session (MTMS) model. This will give the client application independence of operation so that the users local actions are unimpeded by the asynchronous requests from the MCP to distribute local content to other Library Card Members. The whole notion of edge distribution should be considered a background process that is unknown to the local investor.

In order to logically define the “edge” of the community, a client application will need to have certain identifying information. Since network identity is insufficient to characterize the “edge” of the virtual community, identity information needs to be sufficient to both identify the client's network location and also its geographical location within the virtual community. This identity information is used to register the client with the MCP process who maps the client into the virtual community. The network location identity information needs to both identify the client's basic network identity and additionally and information necessary to identify the client as a Peer in the edge of the virtual community.

At least one Primary Session in the client application will be responsible for the direct connection with the MCP. This session(s) will request content from the MCP and process local functions specific to the application. This session will use the local repository to store media of interest, local look and feel preferences, etc. This session will work with the local repository to provide application function in the form of media analysis, playback, and user defined function, etc. It is possible that request for content from the MCP will be redirected to the “edge”. A protocol must be established with the MCP such that requests for content can be identified as coming from the MCP or the “edge”. The client will then need to delegate to a Secondary session to retrieve the content on edge responses.

Now it is entirely possible that there is more than one MCP site if the lower level requirements dictate this necessity from a scalability perspective.

At least one Secondary Session in the client application will be responsible for asynchronous distribution of content on the “edge” of the virtual community. The Primary client connection will delegate MCP requests for content distribution to this session. Since only the MCP knows about the entire virtual community, these requests from the MCP will come in the form of media target identifying information and client routing information. Each client will not know about its nearest neighbors . . . only the MCP will be able to calculate that as it will be able to address the dynamics associated with new clients coming online, leaving the network, or as clients retrieve more content locally and or purge content.

If the MCP decides not to deliver the content itself, then it will calculate nearest candidates in the virtual community and send requests for them to dynamically configure a channel to the target client. Every client will have an established “incoming” channel that is known to the MCP, so it will use this information to tell the surrounding candidates in the virtual community to allocate the new channel and replicate.

The Secondary Session will use the media target information from the request for distribution to retrieve the appropriate media from the local store. The Secondary Session will use the client routing information to setup the channel for media distribution.

How is the client routing information passed to the MCP? Is this done through some sort of pre-built/generalized peer-to-peer protocols that allow any connected client w/Versant to communicate and collaborate?

The client routing information is passed by the local content manager to the MCP The Secondary Session will dynamically allocate a new Peer-to-Peer-channel based on the client routing information and form the aggregation of objects representing the media request and replicate across the channel. In may be anticipated that in order to fulfill a distribution request in a timely manner, a pool of “hollow” distribution channels will need to be created and managed. Upon request for distribution a hollow channel will be retrieved from the pool and Peer information filled in for distribution fulfillment. The channel will need to be persistent and survive long enough to validate and guarantee delivery of the MCP request to the target client at which point the channel will return to the hollow state and be reclaimed to the pool.

At least one Secondary Session in the client will be responsible for retrieving content provide by edge fulfillment responses from the MCP. This session will be responsible for tracking and receiving segments of content from edge participating clients. When all content is retrieved the session will delegate back to the Primary session for content retrieval, assembly and processing from the local store. The MCP will also be responsible for removing non ideal peers from becoming candidates in the secondary session. It will not ask peers to contribute if their bandwidth is below 100 Kb upload and it will limit the number of peers to 5 if the requesting peer is below 100 Kb in download capacity. However it will incrementally increase the number of contributing peers by 5 for every 10 peers with like content this will allow for n+1 redundancy should a connection fail. The total number of candidate peers should never exceed the number of content segments for that content id taking into account n+1.

Master Content Provider:

The master content provider (MCP) is responsible for total content storage, control and management of the virtual community and distribution.

Content-storage and retrieval will need to be managed through a meta data management layer.

Meta data such as

content id,

content description

content kind

content segment lists,

content eff date

content term date

client ids (remote content owners)

user ids (remote content user kinds)

user content lists

campaign ids

campaign values

campaign eff dates

campaign term dates

impression ids

impression date time will be used to quickly manage the state and manipulation of content distribution and reporting. The most critical reporting from the client back to the MCP will impression reports that will include impression id, client id, user id, campaign id, impression date time. The meta data management layer can be thought of as an intelligent indexing mechanism since it will serve to separate the virtual community from the actual storage of media. The meta data layer will provide local managers (controllers) the rules behind the events and methods they generate.

The MCP will be managing many thousands of end users. Therefore, the MCP will need to use features characteristic of application server technology, namely resource and connection pooling for scalability. Functional behavior of the MCP will be defined on a public interface declared through Session Beans and exposed to the remote client applications. In order to be performance oriented, the initial implementations of the MCP will avoid the use of Entity Beans and instead use the Session Beans over a JDO like persistence layer. The JDO layer will also consist of a Multi-Session process that manages the persistent domain model classes defining the Meta data layer and other supporting transient work flow related objects.

Much of the functionality found in the content storage and retrieval of the MCP will be the same as found in the client application because fundamentally, this storage and retrieval is indistinguishable.

The Client side will generate events back to the MCP through pre defined business rules as the meta data/indexing volume will be populated with business rule values for the local/client controllers to retrieve and report.

These managers/controller include:

1. A content manager which will be responsible for passing search string requests from the user to the MCP index volume and presenting available local content in the form of play lists to the user. The content manager create the event necessary as described above to generate a replication of content or report what content it has locally to the MCP.

2. A Skin/Campaign manager which will be responsible for requesting campaigns that define the assignment of a campaign to a particular kind of user. With this assignment will come the meta data that will determine the effective start date and termination date, display rules and indexing of supporting xml/images stored in the system volume. This skin manager will pass this request to the content manager so that the MCP will deliver the content. Its counterpart on the server side will be responsible for populating the index and system volumes with the pre determined values for distribution and disposition. The Skin Manager will also be responsible for generating a report to the local store on the successful impression as described above.

3. Even concepts such as encryption that are essential to secure transfer of content and will be defined close to replication processes will need to exist on both the client and MCP The Encryption manager will also need to access the local store for seed keys and rules on content such that the content can be decrypted before it is passed to a master controller which will pass the decrypted byte stream into the API of a media player.

The major difference in functionality found at the MCP is that of virtual community management. The MCP will need to have the business rules to define who is allowed to retrieve what content, where is content currently distributed in the community, whether to send content to a client on request directly or to respond back with a directive for the client to fork dynamic channels at the edge for content retrieval. Management of the virtual community will require deep navigation of networks of clients via Meta data management layer and the virtual indexing machine.

By utilizing a Meta data layer, the MCP will be able to keep individual transactions short thereby increasing the overall throughput and response time for the entire virtual community. Longer running transactions that will be required when the MCP determines it needs to server content directly will be delegated to another session that is responsible from content delivery.

Application of a Digital Library Card to Advertising Methods

To fully understand how the use of a digital library improves over the use of ordinary banners, internet cookies, and website re-direction links, one needs to consider the following contrast of their elements and limitations.

(i) The Library Card Goes Beyond the Banner

In an effort to better explain assumptions about revenue, the following justification/reasoning explains why the digital library card in context of advertising does not conform to the CPM model. This is true for several reasons, since the advertising marketing associated with a digital library card goes beyond the internet banner to deliver promotions and not advertising. The current CPM model is different the CPE for the library card and does not have the same fundamental traditional costs associated with impression and conversion associated with existing forms of advertising.

(ii) Beyond the Banner:

In addition to banner ads, there are other ways to use the Internet to communicate a marketing message. Traditionally, a banner is an advertisement in the form of a graphic image that typically runs across a Web page or is positioned in a margin or other space reserved for ads. Banner ads are usually Graphics Interchange Format (GIF) images. In addition to adhering to size, many Web sites limit the size of the file to a certain number of bytes so that the file will display quickly. Most ads are animated GIFs since animation has been shown to attract a larger percentage of user clicks. The most common larger banner ad is 468 pixels wide by 60 pixels high. Smaller sizes include 125 by 125 and 120 by 90 pixels. These and other banner sizes have been established as standard sizes by the Internet Advertising Bureau.

Beyond the banner concepts include sponsoring a Web site or a particular feature on it; advertising in e-mail newsletters; co-branding with another company and its Web site; contest promotion; and, in general, finding new ways to engage and interact with the desired audience. “Beyond the banner” approaches can also include the interstitial and streaming video infomercial. The banner itself can be transformed into a small rich media event. In the case of a digital library card, the business method can provide a hybrid of all the current web advertising methods with an interesting difference, the library card user is choosing the time and content to opt in for an impression.

(iii) Promotions not Advertising:

As mentioned above, in Web advertising an ad is almost always a banner, a graphic image or set of animated images (in a file called an animated GIF) of a designated pixel size and byte size limit. An ad or set of ads for a campaign is often referred to as “the creative.” Banners and other special advertising that include an interactive or visual element beyond the usual are known as rich media. In an effort to improve the advertisement/impression some additional techniques have been implemented”
a. Ad rotation: Ads are often rotated into ad spaces from a list. This is usually done automatically by software on the Web site or at a central site administered by an ad broker or server facility for a network of Web sites.
b. Dynamic Ad space: An ad space is a space on a Web page that is reserved for ads. A dynamic ad space group is a predefined group of spaces within a Web site that share the same characteristics so that an ad purchase can be made for the group of spaces.

More and more, advertising agencies struggle with improving there current method of operation with respect to advertising. Some current experts have suggested that interstitials promise to salvage an industry built on hype and relatively innovation less technology. However, there are signs of those who understand the value that cognitive scientists and instructional design experts have known for years and that is the ability for viewers to interact with the advertisement. Banner Ads having you pitch a baseball, chase a ghost using the “PACMAN” style are gaining increased popularity. While these ads provide some level of entertainment and short term retention, in cognitive terms; they fail to demonstrably increase recall, application and transfer. Essentially such advertisements are yet another ad view, synonymous with ad impression, measured only by limited effectiveness.

Affiliate marketing: Affiliate marketing is the use by a Web site that sells products of other Web sites, called affiliates, to help market the products. Amazon.com, the book seller, created the first large-scale affiliate program and hundreds of other companies have followed since. Such providers use links to the websites of others and the links take users to websites offering the product they are seeking.

(iv) Why CPM Does not Apply to the Digital Library Card.

In the traditional non-accountable marketing departments, quantifying the buzz of reach, cost per impression and cost per impression; are for all intensive purposes an after the fact estimation process. From a proactive sense, this traditional “science” doesn't work really well and results in frustration of company management with projecting costs and impacts for advertising campaigns and accurately identifying which advertising has been effective.

CPM may be currently defined as “cost per thousand” ad impressions, an industry standard measure for selling ads on Web sites. This measure is taken from print advertising. The “M” has nothing to do with “mega” or million. It's taken from the Roman numeral for “thousand.” More recently the acronym CPTM, or “cost per thousand targeted” ad impressions, is a term implying that the audience you're selling is targeted to particular demographics.

A digital library card can be associated with user demographics and marketing factor information that can be directly targeted by advertisers. This is well beyond CPTM because an educated end user will recognize that the value they associate with the content they personally choose is worth giving up some degree of information that can be utilized by marketers.

In one embodiment and system for obtaining demographic and marketing targeting information an amnesty library card registration is used. In essence the digital library concept in association with advertising and marketing goes beyond an “opt-in” surrendering of personal information to a value exchange. In affiliation with media providers, amnesty can be provided to registering library card holders for past possible illegal use of digital media (non-payment) if they answer certain identifying questions and agree to become a digital library card holder. In exchange for the pre-existing content of their choosing a network citizen becomes a library card user because they now have the ability to transform their existing content into a vehicle for amnesty, engage in supporting their artists they enjoy and more importantly gain a freedom in choice they only could have if they engaged in illegally or at best immorally. This virtual act of reconciliation allows the past concepts of advertising to be completely rewritten as the industry vernacular associated with ads, booked space, cost per click etc are redefined.

If a digital library card system of advertising becomes widely accepted, internet citizens will no longer be ambushed by undesired pop ups and banners on a website they chose to go to or through the use of a non specific search engine. Instead, they are presented with opportunity that is targeted to them and only them. They will agree to allow this targeting in the ultimate of cognitive environments and with a level of affiliation advertisers in the past could only dream of. When Car commercials insert the Rolling Stones or Madonna into an advertisement they are limited to the acceptance the audience has of Madonna and or the Rolling Stones. If the targeted audience finds the inserted music offensive they will not make a good impression. The known tastes of the digital library card user will allow the advertiser to choose a song that is acceptable to the end user. In this way, positive emotion is conveyed and affiliated with the content and the brand.

Additional details of the advertising method and advertiser auction for sponsored digital media file access or sponsored services, and an assessment of some of the digital library card advertising method's potential changes/impact on existing terminology are provided in another related patent application. The focus of this application is upon the infrastructure that makes such an advertising method and advertiser auction for sponsored digital media possible, plausible and workable.

As exemplified above, the use of a digital library card in the context of advertisers or sponsors targeting consumers will redefine the very definitions of an industry that was reborn when the dot corn boom expanded it. The digital library card and point blank exchange will provide accountability to that very same industry, and delight media buyers around the globe.

Other Applications of the LC, BLTO, DITX and iTEN Technologies

The NAN-e wireless network utilizes-one or more of the LC, DITX and iTEN technologies to provide end users a world where they are essentially always uniquely connected to a network, if a wireless network or wireless telephone system is available. This technology permits the use of current or future wireless connection points (or wireless telephonic access) with no complicated access or expensive airtime, since advertisers can permit end users to use the network for free and pay for their airtime via the point blank exchange . . . or end users can elect to pay a fee that is based upon their exact use of connection time. This is possible with the NAN-e technology because it uniquely identifies the end user device and can be associated with the unique end user for the device. In association with the LC technology and the Point Blank Exchange (PBX) technology an end user can access their home provider service from any wireless connection point and have a third party pay for the connection time. No additional subscriptions, no outrageous fees. End users can stay connected to their current internet provider while away from home. The enterprise security system protects the LC holder and the NAN-e device from being lost, stolen or abused through the systems innovative built in security features that can deactivate a device, locate a device or even identify the new user of the device.

The above technologies permit and make possible a host of communication technologies, from more specific internet searching, connection to verbal and textual language translation services in real time, sophisticated and secure eCommerce or virtual gamming, stock market purchases and the like.

Real time, on the fly, subscription services to entertainment media and business productivity media are possible without paying for media or services that the end user does not use. In addition, third party advertisers can bid on and agree to pay the fees for the end users' use of the entertainment and business productivity media. Software providers can forgo the need for hard copy digital media and unique registry numbers, since end users can quickly download the needed software via a DITX file transfer from any location where the software is currently installed by an end user and pay the provider depending upon their degree of use of the software. This is revolutionary with respect to how software licensing is managed.

Offline use of media is still very much possible without risking digital pirating or loss of revenue for use. Persons who are going to be offline that wish to use particular media can choose an option on their system to download all compressed fragmented packets along with decryption indices and decryption software and maintain those files on their computer system during the offline period. Software will track usage of the media during the offline period and resolve any balances for use upon reconnection to the internet or to another network service. The digital media is utilized from real time decryption and no intact unencrypted digital file will exist on the offline system that can later be pirated or used without the owner of the digital media receiving direct or indirect payment for the offline use of the media or from offline file sharing.

In short, the LC, BLTO, iTEN, NAN-e and DITX technologies will revolutionize Peer-to-Peer or Peer-to-Server communications and file exchanges, while assuring that digital media is not pirated or stolen by end users.

Methods of Loss-Less Encryption and Decryption for Digital Media

The encryption and decryption of a digital media file is both simple and complex.

a. Encryption

Conceptually, in a first step, a digital media file is broken down in to a set of fragments that are uniquely and individually identified fragment and each fragment is also identified as being part of a group of fragments belonging to a specific media file. In a second step, each of the individual fragments is encrypted at least once, and preferably multiple times, to provide an alternate representation of the fragmented information and a separate file is generated regarding how to decrypt the individual fragment in order to retrieve its exact original information or a loss less alternative representation of that information. In a third step the individual encrypted fragments are each converted to programming objects, with the conversion including wrapping each encrypted fragment with metadata that indicates it belongs to a group of associated objects and uniquely identifying the wrapped fragment. This metadata provides an intelligent object that can be distributed over a network with its associated objects, be self aware and aware of its other group members, and be part of a DITX when a file is requested to which the decrypted fragment belongs. In a fourth step, a reassembly index file is generated with data regarding the true order for decryption of the encrypted objects and the data necessary for decrypting the individual objects. In a fifth step, the reassembly index file is itself encrypted at least once, preferably multiple times, in order to provide an encrypted reassembly index. In an optional set of further steps, the encrypted reassembly index may in a further iteration be treated as a media file that is broken into scattered fragments and encrypted as described in five steps set forth earlier in this paragraph in order to provide an even smaller higher-higher level encrypted assembly index file and associated encrypted objects that can be utilized and reassembled to provide the original encrypted reassembly index for the larger media file.

b. Decryption and Reassembly of a Media File

To avoid piracy and unauthorized copying of the media file, the whole media file is not ordinarily decrypted entirely before being utilized. The necessary encrypted data objects from an encrypted media file are retrieved from a local machine or from a local or distributed network Then, decryption software and associated media use programming modules (assuming permission is granted by a “library card” key or set of keys) utilize the encrypted reassembly index to decrypt and reassemble the media file from encrypted data objects in real time. In the case of entertainment media, the file can begin playing as soon as enough encrypted data objects have been decrypted and assembled in the machine's memory or its virtual memory. In the case of programming objects, necessary modules of the software program can be assembled and stored in the machine's memory or virtual memory as the end user requires program functions associated with those software program modules. In some cases, the software modules may be stored in protected access memory areas to avoid pirating. In any case, the entire decrypted media file is not stored permanently in a way that the end user can reassemble the unencrypted media file and transfer it peer-to-peer.

The advantages of this encryption and decryption are clear. They avoid piracy and unwanted access to software, while providing a media industry acceptable peer-to-peer DITX file sharing of digital media files with high internet or wireless download speeds. The library card technology provides a way of monitoring end user access to digital files while ensuring either direct or indirect (third party) payment for use of the digital media.

### EXPERIMENTAL

The following examples are put forth so as to provide those of ordinary skill in the art with a disclosure and description of how to encrypt and decrypt digital media In this example, standard commercially available encryption algorithms were utilized and the data fragments were encrypted three times to compact the files into a smaller size for file transfer.

### Examples of Decryption and Encryption

### Example 1

A 5 megabyte audio file was fragmented and encrypted to provide packets of encrypted data object that collectively are only about 10% of the original audio file size. Concurrently, the encryption/decryption data was compiled and an encrypted reassembly index was generated that was about 1% the size of the original audio file. The individual encrypted data objects and the encrypted reassembly index were then distributed throughout multiple locations on a distributed network system.

Decryption software modules and audio player software modules were installed on a machine with a library card (unique individual identifier software media access keys) that granted the end user rights to access to the original media file.

The end user requested the media player to obtain the audio file for playing and the system sent out a request for media file to the distributed network. Multiple locations on the network responded by sending the encrypted reassembly index and a “swarm” of the individual encrypted data objects from multiple locations to the requesting location, which provided a very high speed DITX download of the encrypted audio file as a torrent of objects.

The decryption software modules obtained the encrypted reassembly index and as soon as the individual encrypted data objects from the torrent of received objects that corresponded to the beginning of the audio file were available began decrypting the individual encrypted data objects and playing the audio media file in real time.

To the end user playing of the media file appeared to be an ordinary retrieval f an audio file from a local storage to be played. To the end user, playing of the audio file was so rapid that it appeared to be a local event rather than a network download with subsequent decryption and playing of the audio file.

Upon viewing the local system the only noticeable file was the small file of about 50 KB having the audio file title, which was actually the encrypted reassembly index for the audio file. After requesting the system to prepare for an offline access to the audio file, the individual encrypted data objects for the audio file were randomly stored in a data source and collectively occupied only about 500 KG of storage space.

### Example 2-10

The steps of Example 1 were repeated with other audio files and other media files to provide essentially and proportionally the same results.

Without further description, it is believed that one of ordinary skill in the art can, using the preceding description, make and utilize the business method and associated computer systems of the present invention and practice the claimed methods. The examples of encryption and decryption specifically point out preferred embodiments of the present invention, and are not to be construed as limiting in any way the remainder of the disclosure. Such examples are non-limiting in that one of ordinary skill (in view of the above) will readily envision other permutations and variations on the invention without departing from the principal concepts. Such permutations and variations are also within the scope of the present invention.

What is claimed is:

1. A computer system having at least some working memory, at least one interface, and at least one software module running in its memory that includes software logic providing a secure private or virtual private network for network users that are identified by the network as having permission for network access as either a member or guest and also providing an enhanced way for advertisers to secure the services of network providers or of the network system in identifying and targeting specific network users or group of users for advertiser sponsoring of all or part of such network user or group of users secure and high speed transmission of media files across an internet, intranet and cable network, or sponsor other network services, in exchange for the network targeted promoting and offering of advertiser's products or services to the targeted network user or group of users, comprising:
(i) computer software including software logic and at least one interface for a network user to be identified by the network as a known prior user, or to provide to the network through the interface enough identifying information to qualify as a newly identified network user, with sufficient permission to access the private or virtual private network,
(ii) computer software including software logic sufficient to verify a network user's identify, and track the network connection of the network user as the network user accesses the private network or virtual private network system, and
(iii) computer software implementing logic with a method for:
(a) accurately identifying and connecting specific network users to the network who wish to access digital media or obtain services offered on the network,
(b) identifying product or services advertisers who wish to target said network users with advertisements in exchange for such advertisers sponsoring such network users free or reduced access or services costs when they access digital media files or obtain services offered on the network,
(c) providing an interface for such product or services advertisers to select network users to target and to obtain the right to target and sponsor such specific network users, and
(d) providing the targeted specific network users with such sponsored digital media access or services.

2. A secure private network or virtual private network according to claim 1, wherein the software enhanced and software supported method includes providing a computer system with software logic implementing at least one method step for accurately identifying the end user of the digital media and at least one method step for a product advertiser to use a computer system to select the target group to which the end user belongs, wherein the software and computer system includes logic and at least one interface for registering or recording data of end users to provide an end users with an actual or virtual digital media card whose unique identifier key (or keys) can be utilized by the private network system, or virtual private network system, for identification and optionally to initiate decoding of encrypted media for the identified end user.

3. A secure private network or virtual private network according to claim 2, further comprising software logic and an interface providing for a media card registration step that includes requesting adequate information from end users related to marketing factors such that the end user may be identified with a particular class of consumers that share at least one marketing factor in common, while optionally preserving their individual identities from advertisers, and the data obtained from the registration step can be accessed by network logic to permit an advertiser to choose to sponsor the access of the end user to digital media or services available on or through the network.

4. A secure private network or virtual private network according to claim 2, wherein the network includes logic and at least one interface providing for the network system to cross reference the media card identity of an network user with consumer information of that end user to make such information accessible to the network system, whereby the media card identity and the consumer information can be used by the network system to provide the network user with access to services available on the network or with access to a media player system having decoding information such that it will allow the media card user to have sponsored access to media files by initiating decoding of such media files in exchange for the media card user being targeted by a sponsor.

5. A secure private network or virtual private network according to claim 2, wherein an identified library card media user is provided with an interface and option to forego sponsored access of a service or sponsored access to a media file available on or through the network, and is provided the option to avoid being targeted by an advertisement by agreeing to directly pay a services fee for such a service, or to pay a media use fee for using digital media whereupon decoding can occur that is cross-referenced with the media card identity and with a file that records payment of the media access fee by of the end user in such a way that it can be tracked by associated network software logic.

6. A stand alone, network connected or internet connected computer system comprising a working memory, a storage device, a logic processor, at least one interface, and software logic for reliably encrypting a digital media file in a compressed/compacted format that provides a degree of security against hackers of the encrypted files, comprising:
(a) software logic for accessing a digital file to produce encrypted scattered digital files, wherein such scattered digital files are generated by:
(i) breaking or disassembling an ordinary digital file into scattered fragments and encrypting each fragments while providing an index for proper reassembly of the digital file, wherein the scattered fragments may be transmitted over the internet or a network utilizing a method similar to bit torrent fragmentation generation and reassembly techniques, except that the reassembly order of the fragments is scrambled, the individual fragments are encrypted and the fragments named without identifying their correct reassembly order, and an a fragment transmission or fragment reassembly index is generated, such that fragment transmission order and fragment names are optionally encrypting
(ii) generating one or more of an encrypted transmission or reassembly index with information regarding the names and order of transmission of fragments by ordered bit torrent, and regarding names, reassembly order and decryption keys for decoding and reassembling decoded fragments temporarily into a portion of the digital file in real time.

7. A network or virtual network comprising at least one encrypted scattered digital file within the private or virtual private network or within a network connected computer, wherein the at least one scattered digital file requires the use of a decryption and reassembly index in order to be accessed and utilized as a digital file, and may require a fragment transmission index, and wherein such decryption and reassembly can only initiated and continued by an end user within the network or within a computer that has acquired such scattered digital file from the network to provide the end user with a digital media access experience in real time if unique user key(s) associated with the network end user are available that grants the end user an access right to the digital media and unlocks with decryption a decryption and reassembly index associated with the at least one encrypted scattered digital file.

8. A network or virtual network according to claim 7, comprising provide software logic and a method to transmit the individual packets of at least one encrypted scattered fragmented digital media file as uniquely identifiable packets whose order for decryption and playing of the packets is included within a separate encrypted reassembly index file, and the individual packets or the encrypted reassembly index file are transmitted to an end user on the network from a single location or from multiple locations simultaneously and asynchronously via a true distributed intelligent torrent exchange transmission.

9. A network or virtual network according to claim 8, wherein the distributed intelligent torrent exchange may be generally described as a file exchange where a torrent of encrypted packets for an encrypted scattered fragmented digital media file are sent from multiple locations on the internet, or from other network locations, to an end user requesting the download and access to the digital media file.

10. A network or virtual network according to claim 8, wherein the distributed intelligent torrent exchange is managed by network software including logic that provides transfer of the encrypted reassembly index file and the first needed packets that correspond to the beginning of the scattered digital media file from the closest locations to permit the quickest real time decryption and use of the digital media file.

11. A network or virtual network according to claim 8, wherein the decryption information of the encrypted reassembly index file operates in real time and only provides a buffer of decrypted media information that exists in the memory of a computer while a portion of the digital media file is being played or accessed by the end user.

12. A network or virtual network according to claim 7, further comprising at least one encrypted decryption and reassembly index, at least one digital file transmission download index, or at least one composite encrypted decryption and reassembly and digital file transmission download index, wherein the at least one encrypted decryption and reassembly index, at least one digital file transmission download index, or at least one composite encrypted decryption and reassembly and digital file transmission download index is readily identifiable to a network end user as being associated with a particular digital media file and can be readily shared with other network or non-network end users without sharing the right to access the index file or to access its associated digital media file, whereby index sharing is encouraged by the network system in order to provide the ability for end users to enjoy sponsored downloading and accessing of the associated digital media file through the network or virtual network as legitimately paid for digital media accessing.

13. A network or virtual network according to claim 12, further comprising software and at least one interface for advertisers to utilize to establish the right to sponsor all or part of an end user downloading and accessing of a digital media file through the network or virtual network as legitimately paid for digital media accessing.

14. A scattered, fragmented and encrypted digital media file or encrypted index generated by the method of claim 6, wherein the digital media file or encrypted index may not be located in a single contiguous file or even in an identifiable digital media or index file, and may not be transferred as decoded digital files by usual file transfer methods.

15. A scattered, fragmented and encrypted digital media file or encrypted index according to claim 14, wherein the scattered, fragmented, encrypted digital media file, the encrypted decryption and reassembly index, or both, is includes or imbedded information regarding where advertisements can be inserted, or when advertisements can be played as part of the digital media access, including before the digital media is played or simultaneously with a part or all of the media access in a window, banner or background.

16. A first encrypted reassembly index according to claim 14, corresponding to a particular scattered digital media file wherein the first encrypted assembly index is further scatter fragmented and further encrypted such that the first encrypted reassembly index requires a second smaller encrypted reassembly index that includes encrypted instructions in order for the first encrypted reassembly index itself to be decrypted and reassembled.

17. A scattered encrypted media file according to claim 14, wherein the scattered encrypted media can be stored as a file or as group of files that are individually or collectively from about 2 to 100 times smaller in file size as compared to the non-encrypted media file or to the collective non-encrypted fragments files in order to promote faster file transfers over the private network or virtual private network.

18. A scattered encrypted media file according to claim 17, wherein the scattered encrypted media can be stored as a file or as group of files which is individually or collectively from about 5 to 10 times smaller in file size as compared to the non-encrypted media file or to the collective non-encrypted fragments files.

19. A network or virtual network according to 12, comprising logic to provide on a receiving end user computer of a network user that is associated with or previously connected with the internet or network for times when the internet or network is unavailable to the end use, encrypted packets for a particular media file and its encrypted reassembly index file which may be stored in separate locations on the receiving end user computer or network and multiple packets may optionally be packed into single or multiple files on the receiving computer or network.

20. A network or virtual network according to claim 19, wherein such file and packet location information may be added to an index upon their receipt and stored in an encrypted or non-encrypted fashion and may optionally utilize a data source within the end user computer system or within an offline network computer associated with the end user computer to store encrypted packets and their corresponding reassembly index in a single file or in multiple separate files that may, or may not be readily associated with one another without the use of a reassembly index.
